(19) United States
(12) Patent Application Publication
(10) Pub. No.: US 2004/0111286 A1
(43) Pub. Date: Jun. 10, 2004

(54) System for the provision of goods and services over a distributed communication network

(76) Inventors: Darren Andrew Koenig, Arlington, VA (US); Gary Michael Novitzkas, Somerset West Cape Town (ZA); Haydn Jan Sleigh, Rolland Castle (GB); Igor Stanisavlev, Reston, VA (US); Vladimir Askovic, Tallahassee, FL (US); Jeffrey David Tyson, Ambler, PA (US); Brady Dale Hoak, Falls Church, VA (US)

Correspondence Address: Darren Koenig, 1122 South 22nd Street, Arlington, VA, 22202, US

(21) Appl. No.: 10/451,767

(22) PCT Filed: Dec. 21, 2001
(86) PCT No.: PCT/US01/49774

(51) Int. Cl. G06F 17/60

(52) U.S. Cl. 705/1

(57) ABSTRACT

The present invention is directed to a real-time logistics and fulfillment system for orders placed on-line that incorporates a real-time closed-loop communication engine to each of a plurality of merchants, having an auto-archive and resubmission capabilities, which provides guaranteed message delivery and response over a communication network. The present invention incorporates a process handler programmed to receive logistical and fulfillment information on an item offered by a merchant from a vendor in real-time upon submission of an order for the item by a customer, and to return the logistical and fulfillment information to the merchant in real-time.

### BACKGROUND OF THE INVENTION

1. Field of the Invention

The present invention generally relates to interactive computer systems, such as interactive Web sites on the Internet and to the provision of goods or services over a distributed communication network, such as the Internet. In particular, the invention relates to a process and a system for providing real-time logistics and fulfillment services for orders placed online.

2. Brief Description of the Prior Art

Computer networks, such as the Internet, intranets, and virtual private networks (“VPN's”), have become increasingly popular for conducting all types of transactions remotely, such as the purchase of products and services or the tracking and coordination of inventory and logistical information. The Internet is a particularly popular medium for these transactions due to the convenience that the purchaser is able to access an unlimited amount of information and can purchase all types of products and services from a single location over an easily accessible public network.

Due to the tremendous growth in these merchant services, on-line merchants are looking for an efficient solution for outsourcing management of back-end logistics and fulfillment processes and functions. These include physical services such as warehousing, pick 'n pack, distribution, end-user order tracking and returns as well as real-time information services such as process flow optimization, inventory analysis, landed cost analysis, lowest cost routing and multiple supply partner management and integration.

Consequently, merchants can significantly benefit from an improved internetworked solution for outsourcing the management of back-end logistics and fulfillment processes and functions.

### SUMMARY OF THE INVENTION

The present invention is directed to a real-time complete logistics and fulfillment system for orders placed on-line that incorporates a real-time closed-loop communication engine to each merchant, having an auto-archive and resubmission capabilities, which provides guaranteed message delivery and response over the Internet and/or other communication media (such as WAP, I-Mode, etc.). The preferred embodiment of the communication engine of the present invention utilizes two modules, a merchant communication module for communicating with a merchant's network servers, and processing communication module for communicating with the merchant communication module and a process handling system.

The merchant communication module is preferably an object that is installed on a merchant's server, which is programmed to send requests to a front-end communication module, and to await a real-time response before allowing further processing of the request. The front-end communication module is preferably installed on an independent, centralized server from the merchant server and the vendor server, although not limited thereto. The front-end communication module is preferably programmed to await requests from the merchant communication module, process them internally, and then send the appropriate response.

Real-time logistics and fulfillment may be accomplished in the present invention among many different merchant and vendor systems by utilizing a platform built on open technology, such as extensible Markup Language (“XML”), which incorporates proconfigured, integrated components for major commerce servers, easy integration with existing solution vendors, such as customer resource management (“CRM”) and payment service providers, and secure access to reporting tools. The present invention may also incorporate a managed service provision network that draws warehousing, delivery and fulfillment services from multiple vendor suppliers and offers them as a single, integrated supplier. A suite of business modeling and analysis tools streamlines operations and improves customer service. This preferably includes real time landed cost analysis, real time inventory checks, stock level triggers and global stock level balancing; and allows for the complete tracking of orders from submission to the merchant through delivery to the customer.

### BRIEF DESCRIPTION OF THE DRAWINGS

FIG. 1 is a diagram of a preferred embodiment of the programmed components of the system of the present invention.

FIG. 2 is a diagram overview of the features of the present invention.

FIG. 3 is a flow chart of the process steps of the system of the present invention.

### DETAILED DESCRIPTION OF THE PREFERRED EMBODIMENTS

The present invention will be understood more fully from the detailed description given below and from the accompanying drawings of preferred embodiments of the invention; which, however, should not be taken to limit the invention to a specific embodiment but are for explanation and understanding only.

The terms “computer”, “computer system”, or “server” as used herein should be broadly construed to include any device capable of receiving, transmitting and/or using information including, without limitation, a processor, microprocessor or similar device, a personal computer, such as a laptop, palm PC, desktop or workstation, a network server, a mainframe, an electronic wired or wireless device, such as for example, a telephone, an interactive television, such as for example, a television adapted to be connected to the Internet or an electronic device adapted for use with a television, a cellular telephone, a personal digital assistant, an electronic pager, and a digital watch. Further, a computer, computer system, or system of the invention may operate in communication with other systems over a communication network, such as, for example, the Internet, an intranet, or an extranet, or may operate as a stand-alone system.

The information to be transmitted in the present invention, as described below, may be in the form of e-mail, Web pages, text files, or any other conventional electronic format capable of conveying information over a communication network. The operation of these media in transmitting information are well known to those of ordinary skill in the art, and will not be further elaborated upon here.

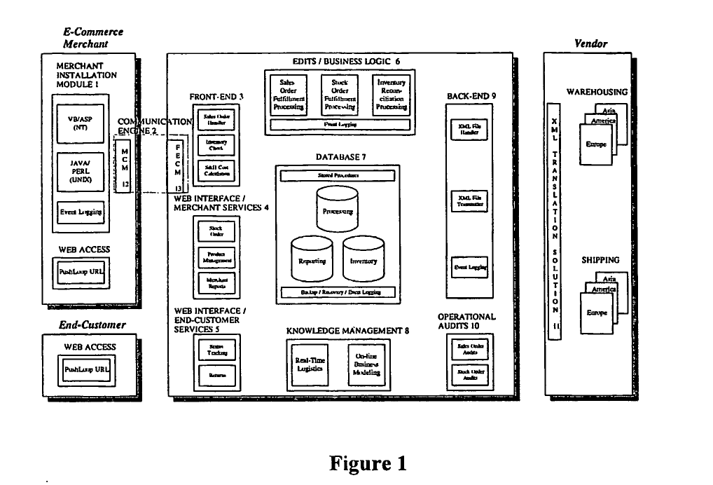

FIG. 1 is a diagram of the general components of the preferred embodiment of the present invention configured to provide a real-time logistics and fulfillment solution among a customer, a merchant, and a supply vendor. Of course, it will be appreciated that, alternatively, a vendor supplier and a merchant may be one in the same. In addition, while the preferred embodiment of the present invention as described below incorporates the use of a separate merchant, vendor, and central server, any number of servers or a single server may be used to operate any and all aspects of the claimed invention.

As shown in FIG. 1, these components include Merchant Installation Module 1, Communication Engine 2, Front-End 3, Merchant Tools 4, End-User Tools 5, Business Logic 6, Database 7, Knowledge Management 8, Backend 9, Operational Audits 10, and XML Translation Solution 11. The operation and interoperation of each of these preferred components in achieving the functionality of the present invention are described in more detail below.

Merchant installation module (MIM) 1 is preferably a software package that is installed onto a merchant's server (which is typically a Web server in embodiments of the invention operated over the Internet). MIM 1 is programmed in a conventional manner to enable merchants to automate the real-time submission of data to Communication Engine (CE) 2 with a built-in response system. The programming of MIM 1, and all of the components of the system of the present invention, may be accomplished using any one of a number of conventional programming languages/systems, such as Visual Basic, JAVA, ASP, PERL, and the like, operating on any one of a number of conventional platforms, such as UNIX or Windows NT.

MIM 1 is also programmed to secure real-time access to database 7 (described in more detail below). If a third party supply vendor is used, MIM 1 is also programmed to enable merchants to submit sales orders to the vendor for the fulfillment and real-time receipt of tracking information, such as a tracking number through the centralized server. This is also discussed in more detail below.

Once the software of MIM 1 is installed onto a merchant's server platform, the software is programmed to integrate and configure with the merchant's storefront application (e.g. a Web store application for Internet-based implementations) in a conventional manner. For example, to perform an inventory check, cost calculation, or sales order submission, function calls may be installed and invoked within the aforementioned scripting language of the merchant's site.

The merchant Web store application will then map data to the parameters used within these function calls in a conventional manner through the use of MIM 1. Those values contain the transaction information (such as product SKU's, shipping address, quantities ordered, desired shipping options, and the like, which are well known to those of skill in the art) that is accessible to the merchant, such as by being stored in database 7, a separate merchant database, or elsewhere.

Failure recovery components may also be included in MIM 1, to ensure that transmissions and valuable transaction information are not lost. These may include, for example, merchant side logging of sales order submissions and merchant side queuing and resubmission of failed sales order. These may be accomplished in any number of conventional ways. For example, each inventory check, cost calculation request, and sales order submission may be logged within the merchant component by being written to a log file, such as a text file, database table, etc. This information may also be used for auditing and during problem resolution. Moreover, if MIM 1 cannot communicate with CE 2, then all submission requests may be placed within a queue folder that resides on the merchant's server, in a conventional manner. The orders may thereafter be re-submitted when the connection is reestablished.

The software of MIM 1 preferably submits the received order to database 7, through CE 2, and a tracking number is generated for the order. This preferably accomplished using an XML formatted message, the operation of which is well known to those of ordinary skill in the art. The tracking number is then preferably passed to the merchant Web store application through MIM 1 by CE 2.

In the preferred embodiment of the present invention CE 2 accomplishes a quick, platform-independent, seamless, and scaleable integration of each merchant through a centralized operation. This is preferably achieved through processes that use a combination of established Internet standards and protocols (such as HTTP, XML, and SOAP) along with other customized components. These standards and protocols and custom-made distributed software objects that may be installed on both a centralized server (not shown) and on each of the merchant servers (such as by MIM 1).

The system of the present invention preferably uses CE 2 to provide several important functions to each merchant web-store. For example, before placing an order for a particular product, the system of the present invention can use CE 2 to tell each merchant (and therefore the merchant's customer) whether the item is currently in stock. The high level logic for this function is preferably as follows: Receive Input parameters from Inventory Check function call; Map input parameters to Inventory Check XML layout; Log Request; Invoke Communication Engine 2; Receive response from Communication Engine 2; Log Response; Interpret Response; and Complete Output parameters for Inventory Check function call.

Another function is cost analysis. Landed cost analysis lets the merchant (and therefore customer) know how much shipping and handling costs will be for a particular order. The high level logic for this function is preferably as follows: Receive Input parameters from Cost Calculation function call; Map input parameters to Cost Calculation XML layout; Log Request; Invoke Communication Engine 2; Receive response from Communication Engine 2; Log Response; Interpret Response; and Complete Output parameters for Cost Calculation function call.

Yet another important function involves sales order submissions. Once all order information has been gathered and submitted in a conventional manner (e.g. through “Buy Button” on an order processing Web page on the merchant's Web site), it is then submitted by the system to a logistics and fulfillment vendor. A tracking number is assigned to the order and returned to the merchant (and therefore to the customer) in real-time fashion. The high level logic for this function is preferably: Receive Input parameters from Cost Calculation function call; Map input parameters to Cost Calculation XML layout; Log Request; Invoke Communication Engine 2; Receive response from Communication Engine 2; Log Response; Interpret Response; and Complete Output parameters for Cost Calculation function call.

In the operation of these functions in the preferred embodiment of the invention, CE 2 preferably comprises two modules: Merchant Communication Module (MCM) 12 and Front End Communication Module (FECM) 13. MCM 12 is preferably an object that is installed on each merchant's server and is programmed to send requests (such as the aforementioned XML formatted messages) to MIM 1 or elsewhere, and to await a real-time response there from before allowing further processing of information back to the customer (e.g. through a web page). FECM 13 is preferably installed on the aforementioned centralized server and is designed to await requests, process them internally, and send responses, as described in more detail below.

MCM 12 and FECM 13 preferably function independently and according to well-established communication protocols. This provides the significant advantage over the system of the prior art that there is no need for any systems integration or merchant design dependencies within CE 2. Thus, FECM 13 may operate as a one-fit-for-all interface for each merchant.

The main carrier for this communication is preferably Simple Object Access Protocol (SOAP). As is well known to those of ordinary skill in the art, SOAP allows for the transfer of closed “envelopes”, regardless of the objects stored in those envelopes. In this case, the envelope preferably contains XML, which is sent from MIM 1 to CE 2 (and from MCM 12 to FECM 13). Within CE 2, the merchant address on the envelope is read first since it contains the information about the process-handling object. The envelope is then opened, contents retrieved and processed by an addressee handler, and finally the response is packaged back into the envelope. The envelope is then returned to the original sender.

This innovative protocol may be used in variety of ways in the present invention. Since the address is built into the protocol and is used to name the component on the other (receiving) side of CE 2, the same engine may thus be used for all interactions between each merchant and the central system, providing an array of merchant services. Components that use SOAP are preferably installed on both ends of CE 2. On the merchant end, there are numerous possible scenarios regarding the use of available platforms. This has the significant advantage of enabling almost 100% coverage of the merchant market.

Once MIM 1 converts merchant data into an XML format, CE 2 is invoked, which results in a secure and seamless submission and receipt of data using SOAP. As a result of transmitting information in this manner, the latency in receiving a response in the system of the present invention is minor, generally shorter than a download of a standard web banner. Moreover, as with MIM 1, in case of network problems, an error mechanism is in place, enabling the merchant component to handle down times (in case of sales order submission time-out, the system of the present invention queues the orders and submits them when the connection is established).

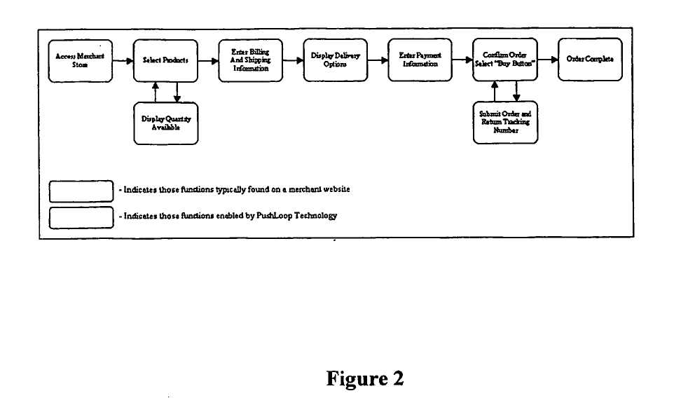

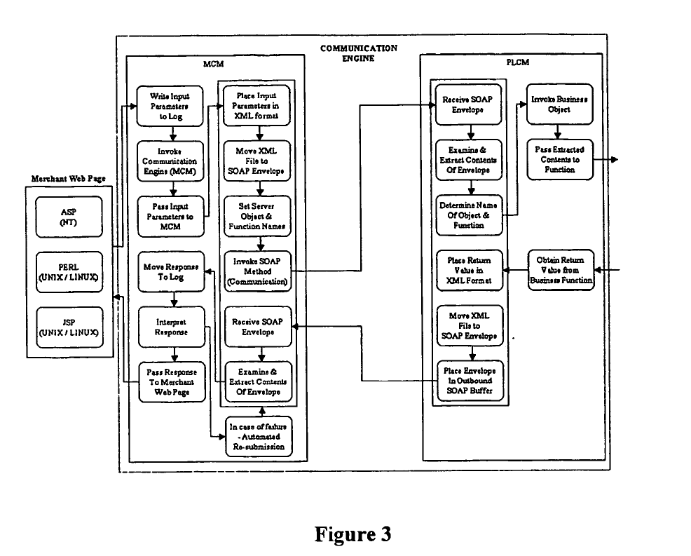

The operation of the features of the system of the present invention is illustrated in FIG. 2, which shows features available to the merchant as a result of the implementation of the system of the present invention. FIG. 3 is a flowchart that details the preferred flow of information and processes performed in CE 2.

Front-end 3 enables communication from the components of the system of the present invention residing on the centralized server to the components residing on the merchant's server. Using front-end 3, the system of the present invention is able to receive information submissions and provide real time responses to and from the merchant, depending upon the type of the request. Front-end 3 is preferably programmed to process merchant requests and produce XML based responses and may include, for example, the transmission of information through a Web server. This programming may be accomplished in any number of conventional ways, as with MIM 1 and CE 2. The processes available to the merchant through front-end 3 preferably include a sales order submission interface, a shipping and handling cost calculator, and an inventory checker. Of course, it will be appreciated to those of ordinary skill in the art that the processes programmed into front-end 3 are not limited thereto, and may include the processing of any information about the items offered by the merchant

In the preferred embodiment, the sales order interface of front-end 3 receives an XML sales order submission request from MIM 1 through CE 2, assigns a tracking number to the order, passes the request to the business logic 6, and sends a response back to the merchant. The response also contains information about success of the submission. While processing a request for a sales order submission, this interface preferably has the capability to validate data submitted by a merchant and produce a response based on the validation process. This has the significant advantage over the prior art that it enables a merchant to produce a real-time response to the customer with either a tracking number or an error message.

The shipping and handling cost calculator of front-end 3 enables a merchant to display real-time shipping and handling cost information on the merchant's web site during the shopping process. The cost information is not an estimate, but the actual shipping and handling cost associated with shipping the selected products in the shopping basket to the selected address. The shipping cost interface of front-end 3 receives the request from MIM 1 through the FECM 13 of CE 2 and processes it as if the order was complete. The cost calculation is preferably done by business logic 6 based on the complex algorithm provided by the shipping vendor, and the price is returned to the merchant for display on the site. The process is seamless and instantaneous to the customer, who only sees a display of the actual cost of shipment for the purchase.

The inventory checking interface of front-end 3 is similar to the cost calculator in design, but the processed information is different. In this case, a merchant submits a request for available inventory in a given geography, and the inventory checking interface accesses database 7 through business logic 6 to obtain the necessary information on the item in a conventional manner. The inventory checking interface then returns the number of available items. Having this information readily available in database 7 enables the merchant to present this number to the customer in real time.

Merchant Tools 4 is preferably a programmed component of the system of the present invention that is implemented through a conventional Web server operating on the centralized server and enables merchants to accomplish several updating and auditing functions on the items that they are offering for sale by using their browser. Theses function include, for example: Add/update product information; Initiate product stocking/re-stocking; View real-time and historical business reports; and Add/Update Product Information

In order to process sales orders, the present invention requires only that a certain minimal amount of product information exist within database 7. This product information includes SKU, Product Name, Description, Weight, and other characteristics. Some of this information is necessary to perform the aforementioned landed cost analysis. Therefore, a simple way to add and update product information is included within Merchant Tools 4.

In order to manage inventories globally, a set of triggers and reminders are in place within Merchant Tools 4 for merchants to use. For example, a merchant can go into merchant tools 4 to set levels of inventory at which it will receive an automated reminder (such as through e-mail) to re-stock a particular product. There are preferably two inventory levels that trigger reminders for restocking of a product: minimal level and critical level. When a product inventory reaches a minimal level, the first reminder is sent. If a product ever reaches the critical level (if it hasn't been restocked), a more urgent message is sent. Merchant tools 4 also allows for these inventory notification levels to be set by the merchant.

Preferably, any time that a merchant wishes to restock inventory, he/she must first log onto the merchant tools web site in order to initiate a stock order notification. This is done through a re-stock web based wizard that guides the users through several steps. First the merchant must log in through multiple levels of security (e.g. database verification, IIS, Windows NT, NTFS, and network IP pool requester validation). Next the merchant selects a vendor supplier warehouse from a global list; and selects products and the re-stock quantities. These are preferably displayed in a table format, to be selected for restocking, with each product requiring a field to specify a quantity for the re-stock. The merchant must then confirm the stock order.

After inserting the order into database 7 and submitting it to the warehouse vendor, the system will provide the merchant with a printable shipping label. Preferably an automated stock order notification must be entered into the system at least 48 hours prior to receipt of the actual shipment at a warehouse location. After submitting the stock order notification, the merchant needs to physically ship the products in question (or request such a shipment from a distributor or a factory). This database driven web wizard provides merchants with a practical tool for complex inventory management tasks. It is intuitive, precise, and requires only a basic knowledge of Internet usage.

A merchant may also wish to view information (inventory levels, recent sales orders, past stock orders, etc.) pertaining to a particular product that is warehoused and shipped through the system of the present invention. To accommodate this need, a list of canned reports is preferably made available to view information at a product level. These product level reports preferably include: Completed Sales Orders for Individual Product; Current Inventory Position for Individual Product; In-Process Sales Orders for Individual Product; In-Process Stock Orders for Individual Product; Completed Stock Orders for Individual Product; Re-Stocked Returns for Individual Product; and Completed Sales Orders Per Customer Location for Individual Product. These reports are prepared by merchant tools 4 in a conventional manner, such as through the use of the aforementioned scripting languages, Web server API's, and the like, which retrieve the necessary information from database 7, format it, and provide it to the merchant via the Web interface.

In addition, the following reports are also preferably available when a merchant wants to view summary or merchant level information (across all merchant products): Products for Merchant; Completed Sales Orders for Merchant; Current Inventory Position for Merchant; In-Process Sales Orders for Merchant; In-Process Stock Orders for Merchant; Completed Stock Orders for Merchant; Re-Stocked Returns for Merchant; Completed Sales Orders Per Customer Location for Merchant; Completed Sales Orders Per Shipment Method for Merchant; NS Average Shipment Time Per Sales Order for Merchant.

Similarly to merchant tools 4, the system of the present invention preferably includes end-user tools 5, also preferably implemented via a Web site. End-user tools 5 are provided to allow a merchant's customers to enter tracking numbers and otherwise track their orders. Users receive tracking numbers and are preferably directed to this Web site through order status e-mails sent by the merchant with or without the use of the system of the present invention. The tools provided to the customers using end-user tools 5 may include, for example: Status Tracking and Returns Processing.

A utility is preferably programmed into end-user tools 5 that allows for a customer to enter his/her tracking number and receive current status of a particular order across multiple markets. Customers may be directed to this Web site, for example, through order status emails generated by the system of the present invention or by the merchant independently. Tracking numbers are preferably communicated to the end-user through status e-mails as well as through the merchant's Web site (e.g. tracking numbers are returned to the merchant in real-time once a sales order has been submitted to the system of the present invention).

In order to process a return, a customer accesses the Web site for end-user tools 5. This will provide the customer with instructions for processing a return and a printable, pre-filled waybill, which should preferably be included with the return. This provides information to the warehousing vendor necessary for restocking of undamaged items. The URL needed to access the Returns Processing utility is preferably provided on the packing list included with the original outbound shipment

Business logic 6 is a programmed component of the system of the present invention that ensures that each piece of data that enters the system is routed through the correct processing or logic, resulting in the completion of the desired function. Some of the major processes that the system of the present invention supports are: Inventory Check; Shipping and Handling Cost Calculation; Sales Order Fulfillment Processing; Stock Order Fulfillment Processing; and Inventory Reconciliation.

The inventory check function is initiated within MIM 1 and is preferably invoked by a merchant (through CE 2) prior to submission of a sales order. Once passed through CE 2 to front-end 3, the next step is to perform the logic necessary to obtain current inventory levels. Business logic 6 uses the defined criteria, such as the product SKU and warehouse location, to retrieve this information from database 7. This information is then sent back to the merchant in a real-time fashion through CE 2, as previously discussed.

The shipping and handling cost calculation is also initiated within MIM 1 and preferably invoked by a merchant prior to submission of a sales order. Once passed through CE 2 to front-end 3, the next step is to perform the logic necessary to perform a landed cost analysis. Business logic 6 uses the defined criteria, including number of products, weight of products, and destination to access reference tables and perform the necessary cost calculations. The result is then sent back to the merchant in a real-time fashion through CE 2, as previously discussed.

Sales order fulfillment processing is triggered when a sales order file is transmitted from the merchant to the system of the present invention. The sales order component of business logic 6 is preferably used to archive, validate, check inventory levels, perform cost calculations, and store data within database 7. Business logic 6 may also read sales order information from database 7 and format it into an outbound transmission file that the fulfillment vendor (warehousing or shipping) will recognize. Sales order fulfillment processing is also triggered when return files are received from logistics and/or fulfillment providers. These return files contain information on sales orders that are currently in process.

Stock order fulfillment processing is triggered when a merchant uses merchant tools 4 to submit a stock order. The stock order information is preferably written to database 7 by a stock order ASP Web page or the like, but is certainly not limited thereto. Business logic 6 preferably reads database 7 looking for all newly created stock orders and format into an outbound transmission file that the fulfillment vendor (warehousing or shipping) will recognize. Stock order fulfillment processing is also triggered when return files are received from logistics and/or fulfillment providers. These return files contain information on stock orders that are currently in process.

Inventory reconciliation processing is triggered by the receipt of an inventory file from each warehouse location. The inventory file contains the current inventory position for each product contained within the warehouse. Business logic 6 preferably checks to make sure that the inventory position in the warehouse inventory file matches the inventory position maintained in database 7. Any discrepancies (within a reasonable threshold) are preferably reported on a daily reconciliation report.

The Backorder processing function creates alternate shipping and delivery scenarios depending on a set of variables controlled by both the merchant and the levels of inventory for a given product. Initially, a merchant determines which major backorder rule to put in place choosing from one of the following: No backorders, immediate fulfillment and assign shipment. In the “no backorder” scenario, all orders placed will be rejected when inventory levels are not sufficient enough to complete the order. In the immediate fulfillment scenario, items in stock at the time the order is placed will be fulfilled immediately. All other items will be placed in a backorder status and will be completed on a “rolling fulfillment” basis as inventory becomes available to fill the order. Finally, the “assign shipment” scenario can help save a merchant reduce shipping costs by assigning all (or some) items in a shipment to a particular shipment. All items in this shipment will be held in the warehouse until inventory is available to ship all items placed in the original sales order corresponding to that shipment.

Other business functions supported by business logic 6 may include Returns Processing and Real-Time Customer Notification. The processing of these functions is accomplished in essentially the same manner as the aforementioned functions, in which the necessary information is retrieved from database 7, the merchant, and the vendor supplier.

Database 7 typically comprises any one of a number of conventional database applications, such as Oracle, Sybase, or SQL Server. The database typically contains inventory levels, shipping, and handling cost information, and other information related to the items offer for sale by the merchant. The details of such information are well known to those of ordinary skill in the art and will not be elaborated upon here. Database 7 is preferably, but not necessarily, subdivided based upon the following types of data: Processing (Sales Order, Stock Order); Inventory; Reporting; History/Archive; and Backup. It will be appreciated by those of skill in the art that this can be accomplished using a variety of well-known database schema and optimization techniques and will also not be further elaborated upon here.

Backend 9 assists with outbound and inbound communication between the system of the present invention and the warehouse and/or shipping vendors. Backend 9 controls the handling and transmitting of files between the system of the present invention and warehouse and/or shipping vendors. As previously described, this is preferably accomplished using XML formatted messages. There are preferably three main areas programmed within the back-end module: XML File Assembler Component; XML File Logging Component; and XML File Transmitting Component.

For outgoing files, business logic 6 assembles item level database records from database 7 for transmission to the vendor. These database records are converted to XML and combined in a single XML ‘batch’ file by the File Assembler Component. Of course, the File Assembler Component may also assemble the XML file based on tracking number. The batch file is archived and then saved into the specific outgoing repository folder for that file type, and the File Transmitting Component preferably sends the batch file to the vendor via FTP. The Logging Component writes the archive and transfer events for auditing.

For incoming files, the above process occurs in reverse. The vendor may rely on the system of the present invention to perform all file transfers and deposits. Thus, the File Transmitting Component monitors the remote FTP folders on the vendor's system for new batch files to retrieve. When found, it transfers it via FTP to the PushLoop incoming repository folder for that specific file type. It then calls the Logging Component, which archives the file into an archive folder. The File Assembler Component then breaks the file into each item record and passes the records to the corresponding business logic process for that record's type (e.g. Stock Receipt, Inventory, Sales Order Status, etc.).

Operational audit 10 is a programmed component of the system of the present invention that may be used to make sure that all the other product components function accurately and efficiently. An event log preferably tracks the steps or events that occur while processing a sale, stock, or other order. The event logs may be audited on a periodic basis to ensure completeness and accuracy of processing. Log files are created for each component of the system, including the MIM 1 and CE 2.

Event logging is preferably performed at the following system processing steps: Transfer of Sales Orders from Merchant to Front-End 3; Transfer of Sales Orders from Front-End 3 to Database 7; Transfer of Sales Orders from Database 7 and Backend 9 to Warehouse and Shipping Vendor; Sales Order Status Progression; Stock Order Status Progression; Backorder Status Progression; Inventory Reconciliation; and Vendor Error File Resolution.

The following daily audit reports may preferably be generated and checked using a combination automated/manual process similar to those described above: Merchant to Front-End 3 Failed Audit Report; Front-End 3 to Database 7 Failed Audit Report; Database 7 and Backend 9 to Warehouse Failed Audit Report; Aging Sales Orders Report (e.g. greater than 3 days old); Warehouse Sales Order Error Report; Warehouse Stock Order Error Report; Aging Backorder Report; and Overdue Stock Receipts (e.g. greater than 4 days overdue). At each of these critical processing steps an archive is preferably taken to ensure that restart recovery can be initiated.

XML Translation Solution 11 is a programmed component of the system of the present invention that allows for the integration of the system of the present invention with a variety of proprietary computing architectures using XML. Since XML is a relatively new technology, it has been discovered that many merchant and vendor systems do not have the tools in place and knowledge in house to process XML files. The resources and knowledge that are required to make such systems conform to XML standards can be difficult, lengthy, and expensive to develop in the systems of the prior art.

Accordingly a solution has been developed in the present invention. Rather than require a merchant or vendor to change their system architecture to handle incoming and outgoing XML files, XML Translation Solution 11 of the present invention allows it to easily snap into the existing legacy systems of merchants and vendors, and enables it to communicate using XML. This is accomplished in the present invention by using a series of translator programs that translate the various legacy data formats of vendors and merchants into an XML format understandable by the system of the present invention (and vice versa). Translations programs are well known to those of ordinary skill in the art and will not be further elaborated upon here.

Although this invention has been described with reference to particular embodiments, it will be appreciated that many variations may be resorted to without departing from the spirit and scope of this invention as set forth in the appended claims.

We claim:

1. A communication system for providing real-time fulfillment information on an order placed by a customer over a communication network with at least one of a plurality of merchants through a merchant server operated by said merchant for at leastone item supplied by at least a plurality of vendors, said communication system comprising:
a process handler programmed to receive fulfillment information on said item from said vendor in at least one of a plurality of data formats and to transmit at least a portion of said fulfillment information to said merchant in real-time.

2. The system of claim 1, wherein said process handler is programmed to perform, in real-time, one or more functions selected from the group consisting of inventory checking of said item in said order, landed cost analysis of said order, order fulfillment, generating tracking information for said order; transmitting said tracking number to said customer; restocking fulfillment processing; inventory reconciliation; and backorder processing.

3. The system of claim 1, further comprising at least one merchant communication module for each of said merchant servers, wherein each of said merchant communication modules is programmed to communicate with one of said merchant servers; and at least one processing communication module, said processing communication module being programmed to communicate with each of said merchant communication modules and said process handler.

4. The system of claim 1, further comprising a merchant installation module programmed to operate on said at least one of said merchant servers, said merchant installation module being programmed to integrate with said merchant server one or more functions selected from the group consisting of real-time submission of said order to said vendor through said process handler, real-time receipt of tracking information for said order from said process handler, inventory checking through said process handler, landed cost analysis through said process handler, and failure recovery if communication with said process handler is lost.

5. The system of claim 3, wherein said failure recovery comprises one or more functions selected from the group consisting of logging of said order on said merchant server, and queuing and resubmission of said order to said process handler.

6. The system of claim 1, wherein said communication among said merchant, said vendor, and said process handler incorporates XML.

7. The system of claim 1, wherein said communication among said merchant, said vendor, and said process handler incorporates SOAP.

8. The system of claim 1, wherein said process handler further comprises a front-end interface, database, and back-end interface.

9. The system of claim 8, wherein said back-end interface comprises an XML file assembler, an XML file logging component, and an XML file transmitting component.

10. The system of claim 8, wherein said database is subdivided based upon one or more types of data selected from the group consisting of Processing of Sales Orders and Stock Orders; Inventory; Reporting; History and Archive; and Backup.

11. The system of claim 1, wherein said process handler is further programmed to provide one or more merchant tool functions selected from the group consisting of updating said item information, management of stock for said item, viewing real-time and historical reports.

12. The system of claim 11, wherein said merchant tool functions further include transmitting a reminder to said merchant when inventory stock for said item reaches a predetermined level.

13. The system of claim 11, wherein said reports include one or more selected from the group consisting of Completed Sales Orders for Individual Product; Current Inventory Position for Individual Product; In-Process Sales Orders for Individual Product; In-Process Stock Orders for Individual Product; Completed Stock Orders for Individual Product; Re-Stocked Returns for Individual Product; Completed Sales Orders Per Customer Location for Individual Product; Products for Merchant; Completed Sales Orders for Merchant; Current Inventory Position for Merchant; In-Process Sales Orders for Merchant; In-Process Stock Orders for Merchant; Completed Stock Orders for Merchant; Re-Stocked Returns for Merchant; Completed Sales Orders Per Customer Location for Merchant; Completed Sales Orders Per Shipment Method for Merchant; and Average Shipment Time Per Sales Order for Merchant

14. The system of claim 1, wherein said process handler is further programmed to provide one or more customer tool functions selected from the group consisting of status tracking and returns processing.

15. The system of claim 1, wherein said process handler further is further programmed to provide one or more operational audit functions selected from the group consisting of Transfer of Sales Orders from Merchant to Front-End; Transfer of Sales Orders from Front-End to Database; Transfer of Sales Orders from Database and Backend to Vendor; Sales Order Status Progression; Stock Order Status Progression; Backorder Status Progression; Inventory Reconciliation; Vendor Error File Resolution; Merchant to Front-End Failed Audit Report; Front-End to Database Failed Audit Report; Database and Backend to Warehouse Failed Audit Report; Aging Sales Orders Report; Warehouse Sales Order Error Report; Warehouse Stock Order Error Report; Aging Backorder Report; and Overdue Stock Receipt

16. The system of claim 1, further comprising a data translator programmed to receive information from said vendor and/or said merchant in plurality of data formats and to translate said data formats to XML.

17. A communication system for providing real-time fulfillment information on an order placed by a customer over a communication network with at least one of a plurality of merchants through a merchant server operated by said merchant for at least one item supplied by at least one of a plurality of vendors, said communications system comprising;
a process handler programmed to receive fulfillment information on said item from said vendor in at least one of a plurality of data formats;
at least one merchant communication module for each of said merchant servers, said merchant communication module being programmed to communicate with said merchant server; and
at least one processing communication module, said processing communication module being programmed to receive said fulfillment information from said process handler and to transmit said fulfillment information to said merchant communication module in real-time.

18. The system of claim 17, wherein said process handler is programmed to perform, in real-time, one or more functions selected from the group consisting of inventory checking of said item in said order, landed cost analysis of said order, order fulfillment, generating tracking information for said order; transmitting said tracking number to said customer; re-stocking fulfillment processing; inventory reconciliation; and backorder processing.

19. The system of claim 17, further comprising a merchant installation module programmed to operate on said at least one of said merchant servers, said merchant installation module being programmed to integrate with said merchant server one or more functions selected from the group consisting of real-time submission of said order to said vendor through said process handler, real-time receipt of tracking information for said order from said process handler, inventory checking through said process handler, landed cost analysis through said process handler, and failure recovery if communication with said process handler is lost.

20. The system of claim 19, wherein said failure recovery comprises one or more functions selected from the group consisting of logging of said order on said merchant server, and queuing and resubmission of said order to said process handler.

21. The system of claim 17, wherein said communication among said merchant, said vendor, and said process handler incorporates XML.

22. The system of claim 17, wherein said communication among said merchant, said vendor, and said process handler incorporates SOAP.

23. The system of claim 17, wherein said process handler further comprises a front-end interface, database, and back-end interface.

24. The system of claim 23, wherein said back-end interface comprises an XML file assembler, an XML file logging component, and an XML file transmitting component.

25. The system of claim 23, wherein said database is subdivided based upon one or more types of data selected from the group consisting of Processing of Sales Orders and Stock Orders; Inventory; Reporting; History and Archive; and Backup.

26. The system of claim 17, wherein said process handler is further programmed to provide one or more merchant tool functions selected from the group consisting of updating said item information, management of stock for said item, viewing real-time and historical reports.

27. The system of claim 26, wherein said merchant tool functions further include transmitting a reminder to said merchant when inventory stock for said item reaches a predetermined level.

28. The system of claim 26, wherein said reports include one or more selected from the group consisting of Completed Sales Orders for Individual Product; Current Inventory Position for Individual Product; In-Process Sales Orders for Individual Product; In-Process Stock Orders for Individual Product; Completed Stock Orders for Individual Product; Re-stocked Returns for Individual Product; Completed Sales Orders Per Customer Location for Individual Product; Products for Merchant; Completed Sales Orders for Merchant; Current Inventory Position for Merchant; In-Process Sales Orders for Merchant; In-Process Stock Orders for Merchant; Completed Stock Orders for Merchant; Re-Stocked Returns for Merchant; Completed Sales Orders Per Customer Location for Merchant; Completed Sales Orders Per Shipment Method for Merchant; and Average Shipment Time Per Sales Order for Merchant

29. The system of claim 17, wherein said process handler is further programmed to provide one or more customer tool functions selected from the group consisting of status tracking and returns processing.

30. The system of claim 17, wherein said process handler further is further programmed to provide one or more operational audit functions selected from the group consisting of Transfer of Sales Orders from Merchant to Front-End; Transfer of Sales Orders from Front-End to Database; Transfer of Sales Orders from Database and Backend to Vendor; Sales Order Status Progression; Stock Order Status Progression; Backorder Status Progression; Inventory Reconciliation; Vendor Error File Resolution; Merchant to Front-End Failed Audit Report; Front-End to Database Failed Audit Report; Database and Backend to Warehouse Failed Audit Report; Aging Sales Orders Report; Warehouse Sales Order Error Report; Warehouse Stock Order Error Report; Aging Backorder Report; and Overdue Stock Receipt.

31. A method for providing real-time fulfillment information on an order placed by a customer over a communication network with at least one of a plurality of merchants through a merchant server operated by said merchant for at least one item supplied by at least one of a plurality of vendors, said method comprising the steps of:
receiving said order from said merchant in real-time;
receiving fulfillment information on said item from at least one said vendors in at least one of a plurality of data formats; and
transmitting at least a portion of said fulfillment information to said merchant in real-time.

32. The method of claim 31, further comprising the step of performing, in real-time, one or more functions of the group consisting of inventory checking of said item in said order, landed cost analysis of said order, order fulfillment, generating tracking information for said order; transmitting said tracking number to said customer; restocking fulfillment processing; inventory reconciliation; and backorder processing.

33. The method of claim 31, further comprising the step of performing one or more functions selected from the group consisting of real-time submission of said order to said vendor through said process handler, real-time receipt of tracking information for said order from said process handler, inventory checking through said process handler, landed cost analysis through said process handler, and failure recovery if communication is lost.

34. The method of claim 33, wherein said failure recovery comprises one or more functions selected from the group consisting of logging of said order on said merchant server, and cueing and resubmission of said order.

35. The method of claim 31, wherein said transmission of said fulfillment information to said merchant is encrypted.

36. The method of claim 31, wherein said transmission of said fulfillment information to said merchant is platform independent.

37. The method of claim 31, wherein said fulfillment information received from said vendor is translated to an XML data format.

38. The method of claim 31, wherein said transmission of said fulfillment information to said merchant is accomplished using XML.

39. The method of claim 31, wherein said transmission of said information to said merchant is accomplished using SOAP.
